(19) United States
(12) Patent Application Publication
(10) Pub. No.: US 2020/0013012 A1
(43) Pub. Date: Jan. 9, 2020

(54) LOGISTICS MANAGEMENT SYSTEM WITH PRICING BASED ON LINKED TRANSPORTATION AND OTHER CHARGE CONTRACTS

(71) Applicant: Unisys Corporation, Blue Bell, PA (US)

(72) Inventors: SUSAN M. DOHM, APEX, NC (US); WILLIAM A. LOEBERTMANN, EAGAN, MN (US); KENNETH L. HOFFMAN, EAGAN, MN (US)

(21) Appl. No.: 16/572,548

(22) Filed: Sep. 16, 2019

Related U.S. Application Data
(63) Continuation of application No. 14/474,424, filed on Sep. 2, 2014.

(51) Int. Cl. G06Q 10/08

(52) U.S. Cl. CPC G06Q 10/08345

(57) ABSTRACT

Systems and methods for performing air waybill pricing may include selecting a first transportation contract to price the transportation of a carriage of goods for the air waybill, wherein the first transportation contract is linked to other charge contracts. Embodiments may also include determining an identifier associated with the first transportation contract that links the first transportation contract to the plurality of other charge contracts. The one or more other charge contracts associated with the same identifier associated with the first transportation contract may be identified, and a price for the carriage of goods may be calculated based at least in part on transportation charges specified in the first transportation contract and other charges specified in the identified one or more other charge contracts. Some embodiments may further include outputting an air waybill that is generated to include at least the calculated price for the carriage of goods.

### FIELD OF THE DISCLOSURE

The instant disclosure relates to logistics management systems (LMSs). More specifically, this disclosure relates to pricing for air waybills (AWBs) in LMSs using linked transportation and other charge contracts.

### BACKGROUND

One application of logistics management is the management of freight shipments. This process can be complex, and often requires coordination of multiple participants, including freight forwards, carriers, and the like. In addition, the process often requires some form of shipment tracking, capacity control of flights, container control, terminal management, cash management, consolidation, and other common freight management tasks.

To assist with this complex process, LMSs have been developed. These systems typically provide computing resources to process freight shipment data, and attempt to aid in scheduling, coordinating and tracking various aspects of the freight shipment. These systems typically require significant data entry, based on current shipping volumes and the number of participants, customers, agents, and other resources that may be associated with the shipments. Because of the complexity of the system and the resources associated with shipments, tasks performed and documents generated by individuals using conventional LMSs are prone to error, thereby requiring corrections that impact the normal flow of business. For example, one document that may be generated by or on behalf of a shipper using an LMS is an AWB. Typically, an AWB is a document that evidences the contract between the shipper and the carrier(s) for carriage of goods over routes of the carrier(s). For example, an AWB may specify a price for the transportation of the carriage based on a transportation contract and may specify a separate list of other charges associated with the transportation of the carriage based on Other Charge Contracts (OCCs). However, because of the complexity of the system and the resources associated with shipments, incorrect OCCs may be applied in the AWB or OCCs that should have been applied may not be identified, and hence not applied in the AWB. As a result, numerous AWB adjustments are often necessary.

### SUMMARY

The number of AWB adjustments that result from incorrect pricing may be reduced by implementing pricing features in LMSs that link transportation contracts to associated other charge contracts. According to one embodiment, a method for pricing the carriage of goods for an air waybill using transportation contracts and other charge contracts may include selecting a first transportation contract to be used for an air waybill to price the transportation of a carriage of goods, wherein the first transportation contract is linked to a plurality of other charge contracts. The method may also include determining an identifier associated with the first transportation contract that links the first transportation contract to the plurality of other charge contracts. The method may further include identifying one or more other charge contracts associated with the same identifier associated with the first transportation contract, wherein the other charge contracts associated with the identifier specify other charges previously negotiated by a shipper and a carrier, and calculating a price for the carriage of goods based at least in part on transportation charges specified in the first transportation contract and other charges specified in the identified one or more other charge contracts. The method may also include outputting an air waybill that is generated to include at least the calculated price for the carriage of goods.

According to another embodiment, a computer program product may include a non-transitory computer-readable medium comprising code to perform the step of selecting a first transportation contract to be used for an air waybill to price the transportation of a carriage of goods, wherein the first transportation contract is linked to a plurality of other charge contracts. The medium may also include code to perform the step of determining an identifier associated with the first transportation contract that links the first transportation contract to the plurality of other charge contracts. The medium may further include code to perform the steps of identifying one or more other charge contracts associated with the same identifier associated with the first transportation contract, wherein the other charge contracts associated with the identifier specify other charges previously negotiated by a shipper and a carrier, and calculating a price for the carriage of goods based at least in part on transportation charges specified in the first transportation contract and other charges specified in the identified one or more other charge contracts. The medium may also include code to perform the step of outputting an air waybill that is generated to include at least the calculated price for the carriage of goods.

According to yet another embodiment, an apparatus may include a memory, and a processor coupled to the memory. The processor may be configured to execute the step of selecting a first transportation contract to be used for an air waybill to price the transportation of a carriage of goods, wherein the first transportation contract is linked to a plurality of other charge contracts. The processor may also be configured to execute the step of determining an identifier associated with the first transportation contract that links the first transportation contract to the plurality of other charge contracts. The processor may be further configured to execute the steps of identifying one or more other charge contracts associated with the same identifier associated with the first transportation contract, wherein the other charge contracts associated with the identifier specify other charges previously negotiated by a shipper and a carrier, and calculating a price for the carriage of goods based at least in part on transportation charges specified in the first transportation contract and other charges specified in the identified one or more other charge contracts. The processor may also be configured to perform the step of outputting an air waybill that is generated to include at least the calculated price for the carriage of goods.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a block diagram illustrating a network-based environment for managing and tracking shipments according to one embodiment of the disclosure.

FIG. 2 is a block diagram illustrating a logistics management system according to one embodiment of the disclosure.

FIG. 3A is a screen shot illustrating a task-oriented user interface presented by the logistics management system according to one embodiment of the disclosure.

FIG. 3B is a screen shot illustrating a task-oriented shortcut menu displayed by the user interface according to one embodiment of the disclosure.

FIG. 4 is a screen shot illustrating a user interface for providing transportation contract information with a logistics management system according to one embodiment of the disclosure.

FIG. 5 is a screen shot illustrating a user interface for providing other contract information with a logistics management system according to one embodiment of the disclosure.

FIG. 6 is a screen shot illustrating a user interface for providing and viewing rate and quote information for the pricing of an AWB with a logistics management system according to one embodiment of the disclosure.

FIG. 7 is a flow chart illustrating a method for pricing the carriage of goods for an air waybill with a logistics management system using transportation contracts and other charge contracts according to one embodiment of the disclosure.

### DETAILED DESCRIPTION

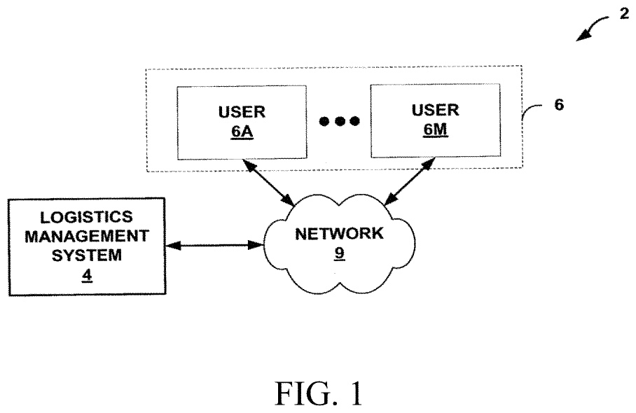

FIG. 1 is a block diagram illustrating an exemplary network-based environment 2 in which logistics management system 4 provides network-based management of freight shipments. As described in detail herein, logistics management system 4 provides a task-oriented user interface with which authorized users 6A-6M (collectively “users 6”) of an airline interact with the system to perform a wide range of tasks associated with shipment management. A user may be, for example, a station manager, office personnel, warehouse staff, space control staff, and the like. Exemplary tasks include capture of shipment data, tracking and tracing shipments, capacity control, container control, terminal management, cash management, consolidation, and other common freight tasks.

Logistics management system 4 presents the user interface as a graphical set of interrelated screens. Regardless of the selected task, logistics management system 4 presents the user interface in a consistent manner that allows the user to perform the task by interacting with a single input screen. Specifically, logistics management system 4 presents each screen to include an item selection region, one or more activity regions, and an action region.

In general, the item selection region allows the user to identify one or more “items,” e.g., a cargo item, a person, an event, a flight, or the like. The activity regions of the screen allow the user to provide input data for a defined set of activities or steps associated with the task, i.e., activities necessary for completion of the overall task. The action region allows the user to perform one or more actions on the item specified with item selection region based on the data specified within activity regions, thereby completing an overall shipment management task with a single action. In this manner, the user need not interact with multiple screens to complete the various activities associated with an overall task.

The task-oriented nature of the interface provided by logistics management system 4 facilitates ease of use by the users, even by relatively untrained individuals. As a result, logistics management system 4 may achieve a reduction in human-related errors, as well reduced training costs. Moreover, by allowing the user to initiate multiple cargo management activities with a single entry, the system may achieve increased employee productivity.

Each user typically accesses logistics management system 4 via network 9 using a remote computing device having suitable communication software, e.g., a web browser. A user may access logistics management system 4 using a network-enabled computing device, such as a workstation, personal computer, laptop computer, or a personal digital assistant (PDA). The communication device executes communication software, such as a web browser, in order to communicate with logistics management system 4.

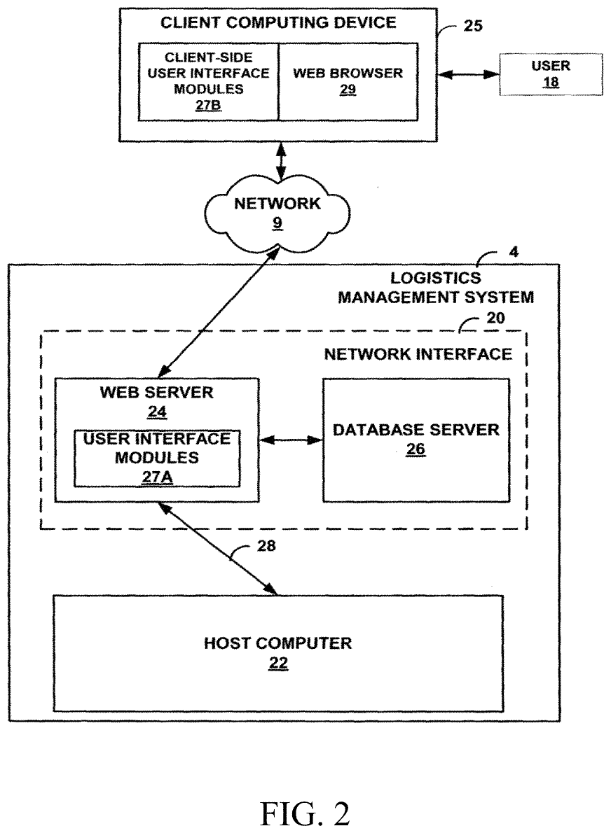

FIG. 2 is a block diagram illustrating an exemplary embodiment of logistics management system 4 in further detail. In the exemplary embodiment, logistics management system 4 includes a host computer 22 coupled to network 9 via network interface 20. In general, host computer 22 provides a computing platform for hosting shipment management services for logistics service providers. Host computer system 22 may comprise, for example, a Unisys 2200 series mainframe executing logistics management software.

Network interface 20 comprises one or more computing devices, e.g., web server 24 and database server 26, that cooperate to provide a seamless, network-based interface by which remote user 18 access host computer 22. Although host computer 22, web server 24, and database server 26 are illustrated separately in FIG. 2 for exemplary purposes, logistics management system 4 may be realized by a single computing device or a plurality of cooperating computing devices.

Web server 24 provides a web-based interface by which an authorized user 18 communicates with logistics management system 4 via network 9. In one configuration, web server 24 executes web server software, such as software marketed by Microsoft Corporation under the trade designation “INTERNET INFORMATION SERVER.” As such, web server 24 provides an environment for interacting with remote user 18 via user interface modules 27A, 27B (collectively “user interface modules 27”). As described in detail below, user interface modules 27 provide a task-oriented interface with which user 18 interacts to perform a wide-range of tasks associated with shipment management. User interface modules 27 may include Active Server Pages, web pages written in hypertext markup language (HTML) or dynamic HTML, Active X modules, Java scripts, Java Applets, Distributed Component Object Modules (DCOM), and the like.

Moreover, user interface modules 27 may comprises “server side” user interface modules 27A that execute within an operating environment provided by web server 24, “client-side” user interface modules 27B that are downloaded to and executed on a client computing device 25 of remote user 18, or combinations thereof. Client-side user interface modules 27B could, for example, include Active X components or Java scripts executed by web browser 29 executing on client computing device 25.

User interface modules 27 interact with data base server 26 to retrieve user-specific information. For example, user 18 may interact with logistics management system 4 to define a variety of preferences for controlling operation of user interface modules 27. Database server 26 may provide an operating environment for a database management system (DBMS) for storing the user-defined preferences. The database management systems may be a relational (RDBMS), hierarchical (HDBMS), multidimensional (MDBMS), object oriented (ODBMS or OODBMS) or object relational (ORDBMS) database management system.

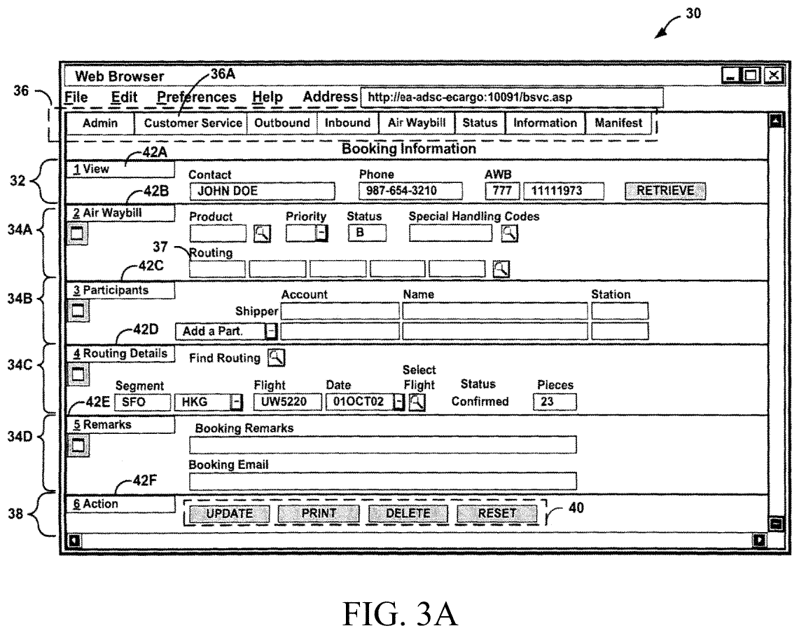

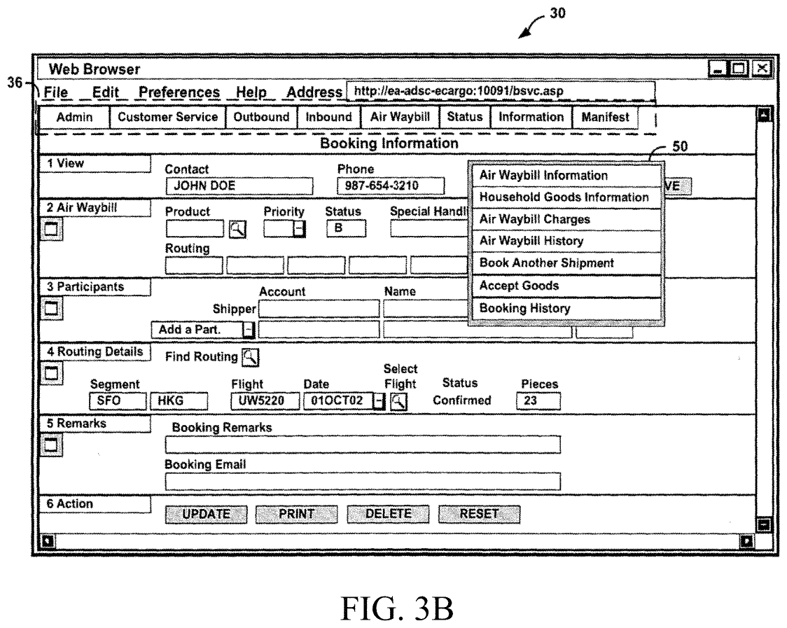

FIG. 3A illustrates an exemplary user interface 30 presented by user interface modules 27 for scheduling and tracking shipments. In the illustrated embodiment, user interface 30 provides menu selection buttons 36 for navigating through a variety of shipment management tasks, e.g., administrative functions, customer service functions, management of outbound freight, management of inbound freight, collecting and maintaining air waybill (AWB) charge information, tracking the status of shipments, and the like. Each menu selection button 36 provides a dropdown menu listing one or more tasks. For example, menu selection button 36A provides a selectable list of tasks relating to maintaining bookings and allotments, finding flight information, providing rate and quote information, providing flight reservations, and the like.

Regardless of the function selected by user 18, user interface modules 27 present user interface 30 in a consistent, task-oriented manner. In particular, as with other input screens presented by user interface modules 27, user interface 30 is divided into at least three regions. An item selection region 32 allows the user to provide an identifier or other information describing one or more “items,” e.g., a cargo item, a person, an event, a flight, or the like. For example, in the exemplary user interface 30 of FIG. 3A, item selection region 32 includes input areas for specifying a contact for an air waybill (AWB). Upon receiving input from user 18 via item selection region 32, web server 24 accesses host computer 22 to retrieve data associated with the specified item.

User interface 30 further includes one or more activity regions 34 for performing a defined set of activities or steps associated with a common task. In particular, user interface 30 presents activity regions 34 within a single window to allow user 18 to perform a complete task for the item specified within item selection region 32. In this example, user interface 30 includes activity regions 34A-34D to capture activity data for performing an overall task associated cargo booking, e.g., creation, modification or deletion of booking activities for the identified item.

More specifically, activity regions 34A-34D present separate input regions that enable user 18 to complete all activities associated with booking a cargo item. Activity region 34A provides input areas with which user 18 interacts to specify an AWB, including a product, priority, status, handling codes, and a complete routing summary 37 that sequentially lists the origin, intermediate, and final destinations of the booked item. Activity region 34B provides input areas by which the user 18 specifies “participants” for the booking, e.g., a shipper, a consignee, an agent, and the like. Activity region 34C provides input regions by which user 18 specifies individual segments for carrier routes to transport the item. Activity region 34D provides input areas by which user 18 specifies general remarks for the booking.

In this manner, user 18 need not interact with multiple screens to complete the booking. Moreover, activity regions 34A-34 may be hierarchically arranged from top to bottom of user interface 30 based on the order in which a user must complete the activities, thus increasing the intuitive nature of user interface 30. For example, user interface 30 may require that user 18 provide routing information 37 prior to allowing the user to select participants via activity region 34B. Similarly, user interface 30 may require that user 18 select participants via activity region 34B prior to allowing the user to specify segment details via activity region 34C.

Finally, user interface 30 includes an action region 38 to perform one or more actions on the item specified with item selection region 32 based on the data specified within activity regions 34. In this example, action region 38 includes selectable buttons 40 that allow user 18 to update, delete, reset and print the selected item.

To further aid in the intuitive, task-oriented nature of user interface 30, user interface modules 27 include respective headers 42A-42F within each of the input regions 32, 34, 36, and may color-code the headers. For example, header 42A of input selection region 34 and header 42F may be presented in a first color. Headers 42B-42E of activity regions 34 may be presented in a second color. Moreover, each header 42 of user interface 30 may be presented in similar manner regardless of the particular screen being displayed, i.e., the function selected via menus 36.

In addition, user interface 30 makes use of dynamic, task-oriented shortcut menus to aid user 18. More specifically, user 18 may select, e.g., via a “right mouse click,” any of regions 32, 34 and 38 to request a shortcut menu to other related tasks. In response, user interface 30 presents a context-sensitive, task-oriented shortcut menu.

FIG. 3B illustrates an exemplary shortcut menu 50 displayed by user interface 30. In this example, user interface 30 presents shortcut menu 50 to include direct links to other tasks provided by logistics management system 4 that are related to the current task being performed via user interface 30. For example, because user interface 30 includes activity regions 34 that relate to the task of booking an item, shortcut menu 50 includes links to other related tasks, e.g., accept goods, view booking history, view all AWB information, view goods information, view AWB charges, view AWB history, and book another shipment. When user 18 is viewing an existing booking, he or she may want to view the booking history, view all the charges associated with the shipment, or accept the goods at a warehouse. Although user 18 may navigate to these tasks via menu selection buttons 36, use of shortcut menu 50 avoids any requirement that the user be familiar with the location of the screens in the menu bar structure and the overall task flow. By making use of shortcut menu 50, user interface modules 27 are able to guide user 18 through a flow of tasks, and allow the user to navigate between screens in a task-oriented manner without requiring the user to have detailed knowledge of menus 36.

Moreover, after activating a shortcut menu to another task, user interface modules 27 pre-fill data values of input areas for the new task according to the screen from which the shortcut menu was launched, e.g., user interface 30. More specifically, data provided in item selection region 32 may be used to automatically populate the item selection region for the subsequent task window. Similarly, data from activity regions 34 may be used to populate activity regions for the subsequent task window. During this process, user interface modules 27 may process data from activity regions 34 to compute or otherwise determine the data for the subsequent activity regions.

Another manner in which user interface modules 27 generate user interface 30 to provide a task-oriented interface is via intelligent cursor control. In response to a tab key input, user interface 30 moves between input areas, but controls the cursor to flow through regions 32, 34, 26 in a manner that corresponds to the logical progression of the activities associated with the task. For example, in some cases the flow of a particular task may dictate that a first field appearing lower on user interface 30 be supplied with data before another field appearing above the first field. In this situation, user 18 can employ the tab key to automatically move to the lower first field prior to the other field, without having to remember the order in which the activities of the task should be completed.

In addition, this functionality can be used to aid user 18 when a shortcut menu, e.g., shortcut menu 50, is employed. In particular, in response to the right click or the context menu key input, user interface modules 27 control the navigation through the fields of a subsequent screen based on the shortcut menu that is used to navigate to the screen. For example, assuming user 18 selects “AWB Charges” from shortcut menu 50, user modules 27 will display a subsequent user interface, and control the navigation through the input areas of the subsequent user interface, based on the fact that the user reached the current interface via a shortcut menu from user interface 30, i.e., the Booking Information interface. That is, user interface modules 27 will control the navigation through the AWB Charges interface based on the fact that a booking-type task is underway or was recently performed by user 18.

In this manner, logistics management system 4 provides a task-based interface that helps guide user 18 through a particular task. These techniques allow a user to easily navigate within a particular screen, e.g., web page, and to screens of related tasks.

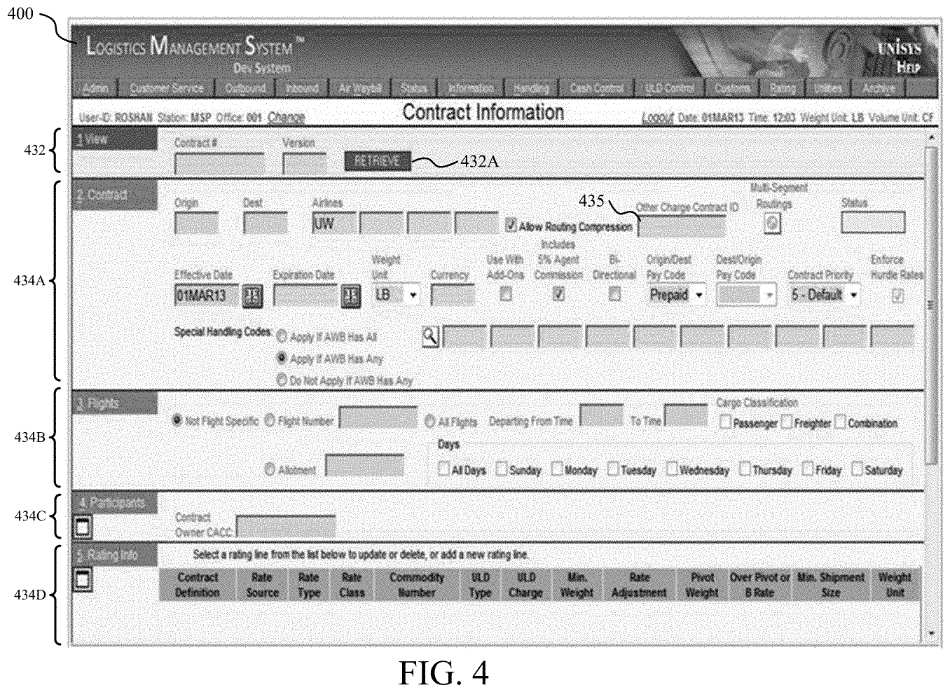

FIG. 4 illustrates a user interface 400 presented by user interface modules 27 for providing transportation contract information. As with other input screens presented by user interface modules 27, user interface 400 may be divided into multiple input regions. An item selection input region 432 allows a user to specify a transportation contract number, which may subsequently be applied to an AWB, and a version of the transportation contract. A retrieve button 432A may also be provided in the item selection region 432 to retrieve data associated with the specified transportation contract. For example, upon receiving input from user 18 via item selection region 432, web server 24 may access host computer 22 to retrieve data associated with the specified transportation contract.

User interface 400 further includes separate input regions 434A-434D to receive data provided by user 18 to complete activities associated with a transportation contract. For example, input region 434A may provide input areas with which a user 18 may interact to specify detailed information for a transportation contract, such as origin, destination, carrier, routing, status, effective date, expiration date, weight units, currency, priority, and special handling information. In addition, as illustrated in user interface 400, input region 434A may also include an input area for a user 18 to specify an identifier, such as Other Charge Contract identifier (OCC ID) 435, to associate with the transportation contract. In some embodiments, the identifier may be used to link the transportation contract to a plurality of other charge contracts.

Input region 434B may provide input areas by which a user may specify information for flights associated with a transportation contract specified in item selection region 432. Input region 434C may provide input areas by which a user may specify “participants” information associated with a transportation contract, such as a shipper, consignee, an agent, and the like. Input region 434D may provide input areas by which a user may specify, update, or delete rating line information associated with a transportation contract.

In this manner, user 18 need not interact with multiple screens to specify various information associated with a transportation contract. Moreover, input regions 434A-434D may be hierarchically arranged from top to bottom of user interface 400 based on the order in which a user must enter information, thus increasing the intuitive nature of user interface 400. For example, user interface 400 may require that user 18 provide contract information prior to allowing the user to select participants via input region 434C.

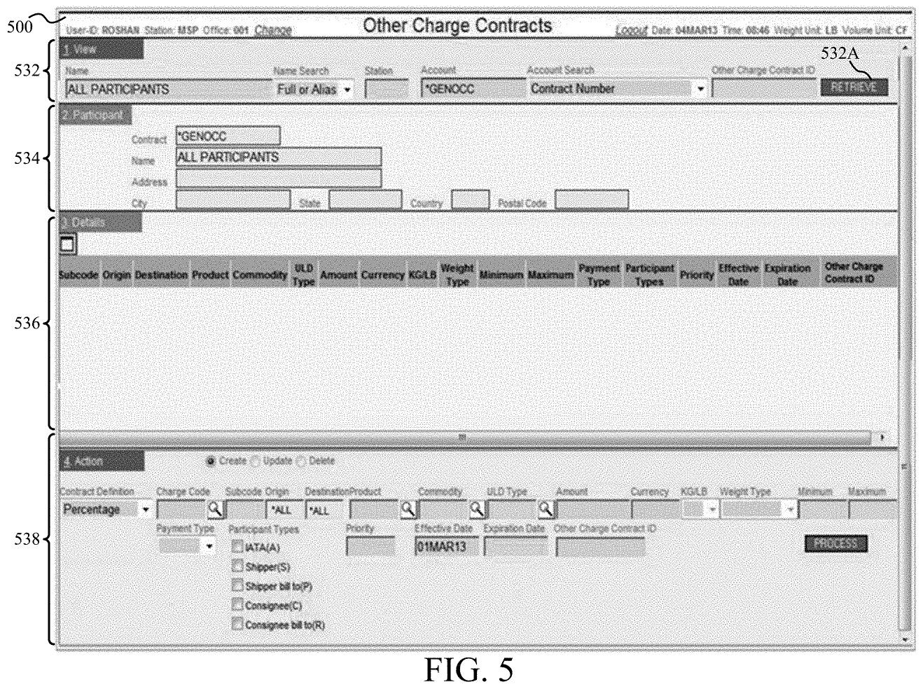

FIG. 5 illustrates a user interface 500 presented by user interface modules 27 for providing OCC information. As with other input screens presented by user interface modules 27, user interface 500 may be divided into multiple input regions. An item selection input region 532 provides input areas with which a user may interact to specify at least a name for an OCC, an account number for an OCC, and an OCC ID to associate with the OCC. A retrieve button 532A may also be provided in the item selection region 532 to retrieve data associated with the specified OCC. In some embodiments, the OCC ID associated with the OCC may be used to link the OCC to a transportation contract. For example, according to an embodiment, the same OCC ID associated with the transportation contract via input region 434A may be associated with an OCC via input region 532 such that when the transportation contract associated with the OCC ID is applied to an AWB, the other charges associated with the AWB may be priced in accordance with the charges/rates specified in other charge contracts with the same OCC ID as the transportation contract applied to the AWB.

User interface 500 further includes separate input regions 534-538 to receive data provided by user 18 to complete activities associated with an OCC. For example, input region 534 may provide input areas by which a user may specify “participants” information associated with an OCC, such as a shipper, consignee, an agent, and the like. Input region 536 may provide input areas with which a user 18 may interact to specify detailed information for an OCC, such as amount, charge code, commodity, contract definition, currency, destination station, effective date, expiration date, minimum, maximum, origin station, participant types, payment type, priority, product, station, subcode, KG/LB, ULD type, or weight type information. Input region 538 provides input areas with which a user may interact to create, update, or delete OCCs based on information specified in input regions 532-538.

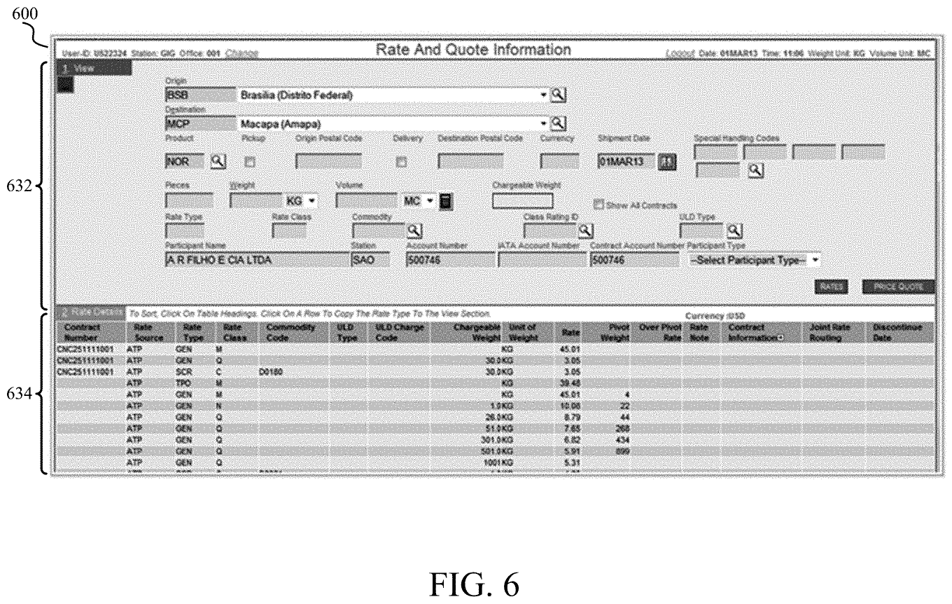

FIG. 6 illustrates a user interface 600 presented by user interface modules 27 for providing and viewing rate and quote information for the pricing of an AWB. An input region 632 provides input areas with which a user may interact to specify rate and quote information, such as origin, destination, product, currency, shipment date, special handling, pieces, weight, volume, rate type, rate class, commodity, class rating ID, ULD type, participant, account, and contract information. Viewing region 634 may provide details associated with rates being applied to an AWB, such as contract number, rate, commodity code, ULD type, ULD charge code, weight, and contract information.

In view of exemplary systems described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

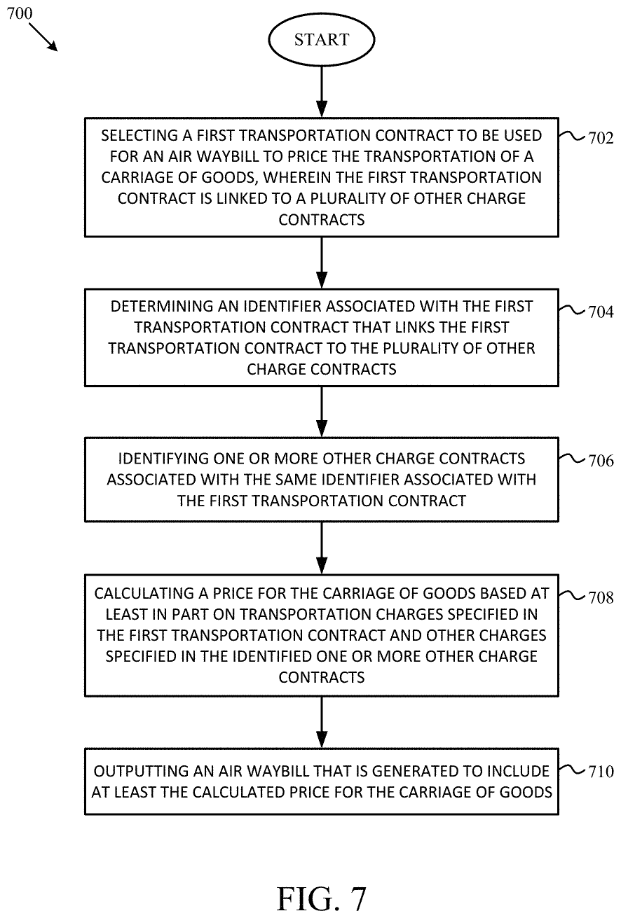

FIG. 7 is a flow chart illustrating a method for pricing the carriage of goods for an air waybill with a logistics management system using transportation contracts and other charge contracts. It is noted that embodiments of method 700 may be implemented with the systems described above with respect to FIGS. 1-6. Specifically, a method 700 begins at block 702 with selecting a first transportation contract to be used for an air waybill to price the transportation of a carriage of goods, wherein the first transportation contract is linked to a plurality of other charge contracts. For example, in one embodiment, a user may select a first transportation contract to be used for an air waybill by entering the contract or account number associated with the transportation contract in input region 632 via user interface 600. In other embodiments, the logistics management system may automatically select a transportation contract to be used for an air waybill.

At block 704, method 700 may determine an identifier associated with the first transportation contract that links the first transportation contract to the plurality of other charge contracts. For example, in one embodiment, the identifier may be received as an input provided by a user via an interface that includes at least one of transportation contract information and OCC information, such as user interface 400. Therefore, in some embodiments, determining may include processing the identifier input by the user. In another embodiment, a history log of generated AWBs, such as an AWB history log, may be searched to determine the identifier associated with the first transportation contract that links the first transportation contract to the plurality of other charge contracts. In some embodiments, validation may be performed by the logistics management system to confirm the existence of an OCC ID before the OCC ID may be associated with a transportation contract to be applied to an AWB. For example, the logistics management system may check that the OCC ID is defined for at least one other charge contract before allowing the OCC ID to be associated with a transportation contract.

At block 706, method 700 may identify one or more other charge contracts associated with the same identifier associated with the first transportation contract. For example, in one embodiment, a user may interact with user interface 400 to associate a transportation contract with an OCC ID, and the user may interact with user interface 500 to associate other charge contracts with an OCC ID. When a user chooses to obtain pricing for an AWB, such as by interacting with user interface 600, the user may specify the transportation contract to be applied to the AWB. In other embodiments, the logistics management system may automatically select an appropriate transportation contract to apply to the AWB. Subsequently, the OCC ID associated with the transportation contract being applied to the AWB may be determined, such as at block 704, and the logistics management system may search for and identify all OCCs associated with the same OCC ID associated with the transportation contract being applied to the AWB.

According to some embodiments, the other charge contracts associated with the identifier specify other charges previously negotiated by a shipper and a carrier. For example, in some embodiments, the other charges may include a fuel charge, a security charge, a delivery charge, and/or a navigation charge. A shipper and a carrier may negotiate a contract specifying a particular rate or charge to be used for pricing the other charges, and the negotiated OCC may be associated with an OCC ID. When a transportation contract with an associated OCC ID is applied to an AWB, the previously negotiated OCCs also associated with the same OCC ID associated with the transportation contract may also be applied to the AWB for more efficient AWB processing.

At block 708, method 700 may calculate a price for the carriage of goods based at least in part on transportation charges specified in the first transportation contract and other charges specified in the identified one or more other charge contracts. For example, the price for transportation may be calculated based on the transportation contract chosen to be applied to the AWB. For other charges also being priced in the AWB, the other charges may be priced based on an OCC associated with the same OCC ID as the transportation contract when an OCC with the same OCC ID as the transportation contract exists for the other charges. When an OCC with the same OCC ID as the transportation contract does not exist for an other charge, the other charge may be priced based on existing applicable pricing rates and logic for the other charge.

In some embodiments, multiple transportation and other charge contracts may be applied to an AWB, and each of the contracts may or may not be associated with an OCC ID. For example, in one embodiment, at least two transportation contracts may be applied to an AWB, with the first transportation contract being associated with an OCC ID and the second not being associated with an OCC ID. In other words, a second transportation contract not linked to a plurality of other charge contracts may be selected to be used for the air waybill to also price the transportation of a carriage of goods. Other charges being applied to the portion of transportation priced according to the first transportation contract associated with an OCC ID may be priced based on one or more OCCs identified as being associated with the same OCC ID as the first transportation contract, such as at block 706. In addition, other charges being applied to the portion of transportation priced according to the second transportation contract not associated with an OCC ID may be priced based on existing applicable pricing rates and logic for the other charges.

At block 710, method 700 may output an air waybill that is generated to include at least the calculated price for the carriage of goods. In addition, a history log of generated AWBs, such as an AWB History log, may be updated to indicate the transportation contracts, associated OCC ID, and other charge contracts that were used to generate the air waybill.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for increasing the system efficiency of a machine-implemented logistics management system that includes a processor coupled to a non-transitory computer-readable memory, the method comprising:
providing a user interface configured and operative to receive user input and control the logistics management system to execute code for:
retrieving, by the logistics management system, in response to the user input via the user interface identifying a first transportation contract between a shipper and a carrier, information from the first transportation contract to be used for an air waybill to price the transportation of a carriage of goods, wherein the first transportation contract is stored separately from a plurality of other charge contracts;
determining, by the logistics management system, an identifier associated with the first transportation contract that is indicative of an association of the first transportation contract with one or more associated other charge contracts from among the plurality of other charge contracts, the determining being based on a search of a computing system-based history log of generated air waybills;
identifying, by the logistics management system, without specific additional user input, the one or more associated other charge contracts and retrieving information from the one or more other charge contracts, wherein the other charge contracts associated with the identifier specify other charges previously negotiated by the shipper and the carrier;
calculating, by the logistics management system, a price for the carriage of goods based at least in part on transportation charges according to the information retrieved from the first transportation contract, and other charges according to the information retrieved from the one or more associated other charge contracts; and
outputting, by the logistics management system, an air waybill that is generated to include at least the calculated price for the carriage of goods.

2. The method of claim 1, wherein providing the user interface enables a user to perform activities associated with the retrieving, the determining, and the calculating from a single user interface screen.

3. The method of claim 1, wherein the user interface allows the processor to access an independent logistics resource without requiring the administrator to identify the resource.

4. The method of claim 1, wherein the plurality of other charge contracts specify charges comprising at least one of:
a security charge;
a delivery charge; and
a navigation charge.

5. The method of claim 1, further comprising:
selecting a second transportation contract to be used for the air waybill to price the transportation of a carriage of goods, wherein the second transportation contract is not linked to a plurality of other charge contracts; and
calculating the price for the carriage of goods based at least in part on transportation charges specified in the first and second transportation contracts, other charges specified in the identified one or more other charge contracts, and existing applicable pricing rates for other charges.

6. The method of claim 1, further comprising validating the existence of the identifier, wherein validating comprises checking that the identifier is defined for at least one other charge contract.

7. A computer program product for increasing the system efficiency of logistics management systems, comprising:
a non-transitory computer-readable medium comprising instructions that, when executed on a processor-based logistics management system, cause the system to perform operations including:
in response to user input via a user interface identifying a first transportation contract between a shipper and a carrier, retrieving information from the first transportation contract to be used for an air waybill to price the transportation of a carriage of goods, wherein the first transportation contract is stored separately from a plurality of other charge contracts;
determining an identifier associated with the first transportation contract that is indicative of an association of the first transportation contract with one or more associated other charge contracts from among the plurality of other charge contracts, the determining being based on a search of a computing system-based history log of generated air waybills;
identifying, without specific additional user input, the one or more associated other charge contracts and retrieving information from the one or more other charge contracts, wherein the other charge contracts associated with the identifier specify other charges previously negotiated by the shipper and the carrier;
calculating a price for the carriage of goods based at least in part on transportation charges according to the information retrieved from the first transportation contract, and other charges according to the information retrieved from the one or more associated other charge contracts; and
outputting an air waybill that is generated to include at least the calculated price for the carriage of goods.

8. The computer program product of claim 7, wherein providing the user interface enables a user to perform activities associated with the retrieving, the determining, and the calculating from a single user interface screen.

9. The computer program product of claim 7, wherein the user interface allows the processor to access an independent logistics resource without requiring the administrator to identify the resource.

10. The computer program product of claim 7, wherein the plurality of other charge contracts specify charges comprising at least one of:
a security charge;
a delivery charge; and
a navigation charge.

11. The computer program product of claim 7, wherein the medium further comprises code to perform the steps of:
selecting a second transportation contract to be used for the air waybill to price the transportation of a carriage of goods, wherein the second transportation contract is not linked to a plurality of other charge contracts; and
calculating the price for the carriage of goods based at least in part on transportation charges specified in the first and second transportation contracts, other charges specified in the identified one or more other charge contracts, and existing applicable pricing rates for other charges.

12. The computer program product of claim 7, wherein the medium further comprises code to perform the step of validating the existence of the identifier, wherein validating comprises checking that the identifier is defined for at least one other charge contract.

13. An apparatus for increasing the system efficiency of logistics management systems, comprising:
a memory; and
a processor coupled to the memory, the processor configured, via a user interface, to execute operations that include:
retrieving, in response to user input via the user interface identifying a first transportation contract between a shipper and a carrier, information from the first transportation contract to be used for an air waybill to price the transportation of a carriage of goods, wherein the first transportation contract is stored separately from a plurality of other charge contracts;
determining an identifier associated with the first transportation contract that is indicative of an association of the first transportation contract with one or more associated other charge contracts from among the plurality of other charge contracts, the determining being based on a search of a computing system-based history log of generated air waybills;
identifying, without specific additional user input, the one or more associated other charge contracts and retrieving information from the one or more other charge contracts, wherein the other charge contracts associated with the identifier specify other charges previously negotiated by the shipper and the carrier;
calculating a price for the carriage of goods based at least in part on transportation charges according to the information retrieved from the first transportation contract, and other charges according to the information retrieved from the one or more associated other charge contracts; and
outputting an air waybill that is generated to include at least the calculated price for the carriage of goods.

14. The apparatus of claim 13, wherein providing the user interface enables a user to perform activities associated with the retrieving, the determining, and the calculating from a single user interface screen.

15. The apparatus of claim 13, wherein the user interface allows the processor to access an independent logistics resource without requiring the administrator to identify the resource.

16. The apparatus of claim 13, wherein the plurality of other charge contracts specify charges comprising at least one of:
a security charge;
a delivery charge; and
a navigation charge.

17. The apparatus of claim 13, wherein the processor is further configured to perform the steps of
selecting a second transportation contract to be used for the air waybill to price the transportation of a carriage of goods, wherein the second transportation contract is not linked to a plurality of other charge contracts; and
calculating the price for the carriage of goods based at least in part on transportation charges specified in the first and second transportation contracts, other charges specified in the identified one or more other charge contracts, and existing applicable pricing rates for other charges.

18. The apparatus of claim 13, wherein the processor is further configured to perform the step of validating the existence of the identifier, wherein validating comprises checking that the identifier is defined for at least one other charge contract.
